(19) United States
(12) Patent Application Publication
(10) Pub. No.: US 2017/0153751 A1
(43) Pub. Date: Jun. 1, 2017

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: Yoshiteru Horiike, Matsudo-shi (JP)

(21) Appl. No.: 15/359,311

(22) Filed: Nov. 22, 2016

(30) Foreign Application Priority Data
Nov. 28, 2015 (JP) 2015-232524

(51) Int. Cl. G06F 3/041; G06F 3/045; H04N 1/00; G06F 3/044

(52) U.S. Cl. CPC G06F 3/0416; G06F 3/044; G06F 3/045; H04N 1/00411; H04N 1/0044; H04N 1/00795; H04N 2201/0094; G06F 2203/04104

(57) ABSTRACT

An information processing apparatus includes a connection unit configured to connect a touch panel of a first type or a touch panel of a second type, a display unit configured to display an image, a calculation unit configured to calculate a distance between at least two points of touched positions on a touch panel connected to the connection unit, a display control unit configured to enlarge or reduce the displayed image according to an amount of change in the calculated distance exceeding a threshold value, and a setting unit configured to set different values between the threshold value used when the touch panel of the first type is connected to the connection unit and the threshold value used when the touch panel of the second type is connected to the connection unit.

### BACKGROUND OF THE INVENTION

Field of the Invention

The aspect of the embodiments relates to an information processing apparatus to which a plurality of touch panels of different types can be connected, a control method of the information processing apparatus, and a storage medium.

Description of the Related Art

In recent years, information processing apparatuses including a touch panel capable of detecting multi-touch operations have been commonly provided in order to enable users to perform intuitive operations. Further, image processing apparatuses (multifunction peripherals (MFPs)) having a copy function and a printing function that includes a multi-touch panel have gradually appeared. The multi-touch operations performed on the multi-touch panel include pinch operations such as “pinch-in” and “pinch-out”. The “pinch-in” refers to an operation in which a user moves the user's two fingers close together in such a way as to pinch a target object displayed on the touch panel. The user can intuitively execute reduction of the target object through the pinch-in. Further, the “pinch-out” refers to an operation in which a user moves the user's two fingers away from each other in such a way as to spread a target object displayed on the touch panel. The user can intuitively execute enlargement of the target object through the pinch-out.

Generally, in the above-described products, a predetermined threshold value for determining whether to execute enlargement or reduction through the pinch operations is set. More specifically, when the touch panel is touched with two fingers, touched positions are detected at two points while a distance between the two points is calculated. When an amount of change in the distance between the two points exceeds a predetermined threshold value, enlargement or reduction of an image is executed. As described above, setting a predetermined threshold value makes it possible to prevent an image from being enlarged or reduced, without intention of the user, through a subtle movement of the user's fingers that touch the touch panel.

Japanese Patent Application Laid-Open No. 2013-190982 discusses a technique for reducing an image enlarged and displayed on a display through a pinch-in operation.

Herein, electrostatic capacitance type touch panels and resistance film (pressure-sensitive) type touch panels are known as examples of the touch panels capable of detecting the multi-touch operations. Although the electrostatic capacitance type touch panels can acquire position information with high precision because a position is detected by capturing a change in the electrostatic capacitance between a finger and a conductive film, the electrostatic capacitance type touch panels cost higher than the resistance film type touch panels. The resistance film type touch panels detect a position through a pressure applied by a finger or a stylus pen, and thus the detection precision of position information is lower than that of the electrostatic capacitance type touch panels.

Touch panels of a type determined by a manufacture are mounted on standard products such as MFPs for general users or smartphones. In recent years, electrostatic capacitance type touch panels that are capable of detecting position information more highly precisely tend to be employed.

On the other hand, depending on apparatuses, a type of touch panels to be mounted thereon may be changed according to a preference of a user as a sales destination. For example, although a plane face operation panel (plane face operation panel 102 in FIG. 1A) is mounted as a standard touch panel on a professional-use MFP such as a print on demand (POD), an elevation face operation panel is also provided as an option for a user who feels difficulty in working on the plane face operation panel. If the user purchases the elevation face operation panel (elevation face operation panel 103 in FIG. 1B) as an option, the elevation face operation panel is connected thereto instead of the plane face operation panel. Herein, touch panels of different types may be employed between plane face operation panels and elevation face operation panels. For example, because the plane face operation panels can be also used as the operation panels mounted on other MFPs for general users, the electrostatic capacitance type touch panel may be employed for the plane face operation panel mounted on the POD as a standard feature. On the other hand, because a production quantity of the elevation face operation panels is lower than the production quantity of the plane face operation panels, the resistance film type touch panel may be employed for the elevation face operation panel provided as the option in order to reduce the cost.

In a case of an apparatus to which touch panels of different types can be connected, if a threshold value is fixed as described above, the following situations may arise. For example, it is assumed that a resistance film type touch panel is connected in a state where a threshold value appropriate for an electrostatic capacitance type touch panel is set to the apparatus. In this case, because of an influence of the detection precision of position information, an amount of change in a distance between two detected points exceeds the threshold value, and the image may be enlarged or reduced even if the movement of the finger is so subtle that an image would not be enlarged or reduced by the electrostatic capacitance type touch panel. On the contrary, in a case where an electrostatic capacitance type touch panel is connected in a state where a threshold value appropriate for a resistance film type touch panel is set to the apparatus, the image will not be instantly enlarged or reduced even if the user moves the user's fingers, and thus the image will not be displayed smoothly and comfortably for the user.

### SUMMARY OF THE DISCLOSURE

According to an aspect of the embodiments, an information processing apparatus includes a connection unit configured to connect a touch panel of a first type or a touch panel of a second type, a display unit configured to display an image, a calculation unit configured to calculate a distance between at least two points of touched positions on a touch panel connected to the connection unit, a display control unit configured to enlarge or reduce the displayed image according to an amount of change in the calculated distance exceeding a threshold value, and a setting unit configured to set different values between the threshold value used when the touch panel of the first type is connected to the connection unit and the threshold value used when the touch panel of the second type is connected to the connection unit.

Further features of the disclosure will become apparent from the following description of exemplary embodiments with reference to the attached drawings.

### BRIEF DESCRIPTION OF THE DRAWINGS

FIGS. 1A and 1B are diagrams illustrating exterior views of an image processing apparatus according to an exemplary embodiment. FIG. 1C is a block diagram illustrating an example of a hardware configuration of the image processing apparatus according to the exemplary embodiment.

FIGS. 2A, 2B, and 2C are diagrams illustrating examples of screens displayed on a display of the image processing apparatus according to the exemplary embodiment.

FIG. 3A is a graph illustrating an example of position coordinates detected when fingers are held in a stationary state in a multi-touch operation. FIGS. 3B and 3C are graphs illustrating examples of time variations of position coordinates detected when fingers are held in a stationary state in a multi-touch operation.

FIG. 4 (4A and 4B) is a flowchart illustrating processing executed by the image processing apparatus.

### DESCRIPTION OF THE EMBODIMENTS

Hereinafter, an exemplary embodiment of the disclosure will be described with reference to the appended drawings. Further, the embodiment described hereinafter is not intended to limit the content of the disclosure as described in the appended claims, and not all of the combinations of features described in the exemplary embodiment are applicable as the solutions of the disclosure.

### <Exterior Configuration>

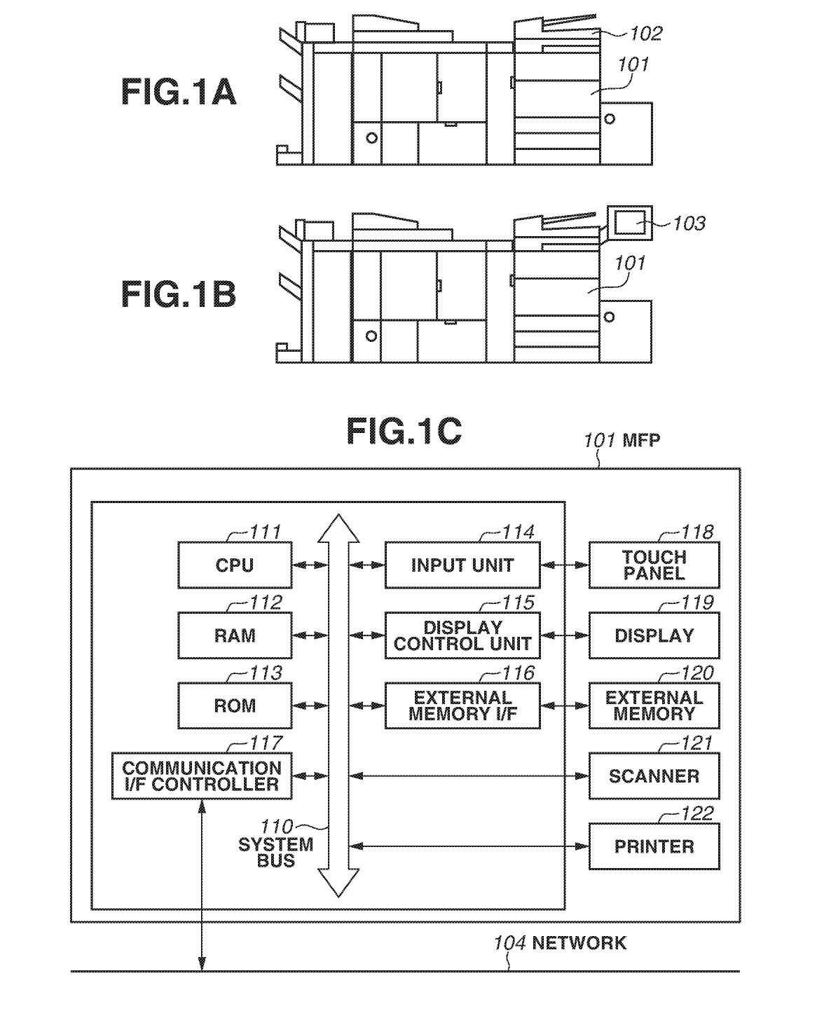

FIGS. 1A and 1B are diagrams illustrating exterior views of an image processing apparatus according to the present exemplary embodiment. In the present exemplary embodiment, the image processing apparatus will be described by taking a multifunction peripheral (MFP) as an example.

An MFP 101 according to the present exemplary embodiment is configured in such a state that any one of touch panels of an electrostatic capacitance type and a resistance film type is connectable according to a requirement of a user as a sales destination. FIG. 1A is a diagram illustrating an example of the MFP 101 to which a plane face operation panel 102 using the electrostatic capacitance type touch panel is attached. FIG. 1B is a diagram illustrating an example of the MFP 101 to which an elevation face operation panel 103 using the resistance film type touch panel is attached.

### <Hardware Configuration>

FIG. 1C is a block diagram illustrating an example of a hardware configuration of the MFP 101.

The MFP 101 includes respective units of a CPU 111 to a printer 122. The CPU 111, a RAM 112, a ROM 113, an input unit 114, a display control unit 115, an external memory interface (I/F) 116, and a communication I/F controller 117 are connected to a system bus 110. Further, a scanner 121 and a printer 122 are connected to the system bus 110. Each of the processing units can mutually exchange data via the system bus 110. The CPU 111, the RAM 112, and the ROM 113 are abbreviations of “central processing unit 111”, “random access memory 112”, and “read only memory 113”, respectively.

The ROM 113 is a non-volatile memory, and image data, other data, and various programs causing the CPU 111 to execute operations are respectively stored in predetermined regions thereof. The RAM 112 is a volatile memory and used as a temporary storage region such as a main memory or a work region of the CPU 111. For example, according to the program stored in the ROM 113, the CPU 111 uses the RAM 112 as a work memory to control respective units of the MFP 101. Further, the programs that cause the CPU 111 to execute operations may be previously stored not only in the ROM 113 but also in the external memory (i.e., hard disk) 120.

The input unit 114 receives a user's operation, generates a control signal according to the operation, and supplies the control signal to the CPU 111. For example, the input unit 114 receives a user's operation through a keyboard (not illustrated), a mouse (not illustrated), or the touch panel 118 functioning as an input device.

In addition, the touch panel 118 is an input device that outputs coordinate information according to a touched position in the input unit 114 configured in a planar state or an elevational state. As described above, according to the present exemplary embodiment, any one of the plane face operation panel 102 employing the electrostatic capacitance type and the elevation face operation panel 103 employing the resistance film type can be connected as the touch panel 118.

Based on a control signal generated and supplied by the input unit 114 according to a user operation performed on the input device, the CPU 111 controls respective units of the MFP 101 according to the program. With this control, the MFP 101 can operate according to the user operation.

The display control unit 115 outputs a display signal for displaying an image on the display 119. For example, the CPU 111 supplies a display control signal generated according to the program to the display control unit 115. The display control unit 115 generates a display signal based on the display control signal, and outputs the display signal to the display 119. For example, the display control unit 115 causes the display 119 to display a GUI screen that constitutes a graphical user interface (GUI) based on the display control signal generated by the CPU 111.

In addition, the touch panel 118 and the display 119 are configured integrally, so as to function as a touch panel display. For example, a manufacturer forms the touch panel 118 so as not to make the light transmittance interfere with a display of the display 119, and attaches the touch panel 118 on an upper layer of a display face of the display 119. Then, the manufacturer associates an input coordinate on the touch panel 118 with a display coordinate on the display 119. Thus, a GUI that enables a user to directly operate a screen displayed on the display 119 is configured.

An external memory 120 such as a hard disk, a floppy (registered trademark) disk, a compact disc (CD), a digital versatile disc, or a memory card can be attached to the external memory I/F 116. Based on the control of the CPU 111, the external memory I/F 116 reads or writes data from/to the attached external memory 120. Based on the control of the CPU 111, the communication I/F controller 117 executes communication with respect to various networks 104 such as a LAN, the internet, and a wired or wireless network. Various devices such as a personal computer (PC), another MFP, a printer, and a server are connected to the network 104 so as to be communicable with the MFP 101.

A scanner 121 reads an image on an original document and generates image data. The generated image data is stored in the RAM 112 or the ROM 113. A printer 122 prints and outputs the image data on a recording medium based on an instruction of a user input via the input unit 114 or a command input from an external device via the communication I/F controller 117. Further, the printer 122 realizes a copy function by executing printing based on the image data generated by the scanner 121.

In addition, the CPU 111 can specify the following gesture operations performed on the touch panel 118 and states thereof. Touching the touch panel 118 with a finger or a pen (i.e., input pointer) is referred to as “touch-start”. Continuously touching the touch panel 118 with the input pointer is referred to as “touch-move”. Removing the input pointer that has touched the touch panel 118 is referred to as “touch-end”.

The above operations or touch position coordinates on the touch panel 118 is notified to the CPU 111 through the system bus 110, so that the CPU 111 specifies the operation performed on the touch panel 118 based on the notified information. A moving direction of the input pointer moving on the touch panel 118 can be determined at each of a vertical component and a horizontal component of the touch panel 118 based on the change in the position coordinates.

Further, quickly performing the touch-end after performing the touch-start on the touch panel 118 is referred to as “click”. Furthermore, a stroke is drawn by performing the touch-end after a certain extent of the touch-move from the touch-start on the touch panel 118. An operation for quickly drawing a stroke is referred to as “flick”. The flick is an operation in which a finger is quickly moved on the touch panel 118 by a certain distance in a touched state and removed subsequently, which is an operation for quickly sweeping or flicking the touch panel 118 with the finger.

Based on the change in the position coordinates of the detected touch-move, the CPU 111 detects that the input pointer has moved by a distance equal to or greater than a predetermined distance at a speed equal to or greater than a predetermined speed, and determines that the flick is performed when the touch-end is detected subsequently. Further, when the CPU 111 detects that the input pointer has moved by a predetermined distance or more based on the change in the position coordinates of the detected touch-move, the CPU 111 determines that the drag is performed.

In addition, because the touch panel 118 supports the multi-touch operations, a plurality of positions where the touch-start or the touch-move is performed can be detected simultaneously. In a state where the touch panel 118 is touched with two fingers at two points, the user may move the fingers in a direction of a line segment that connects the two points to increase or decrease a distance therebetween. The above operation in which the user moves the two fingers close together or away from each other is referred to as “pinch operation” because the operation just resembles an act of pinching or stretching an object. An operation of increasing a distance between the two fingers on the touch panel 118 is referred to as “pinch-out”, whereas an operation of decreasing the distance between the two fingers is referred to as “pinch-in”.

Generally, the pinch operation is performed by using a thumb and a forefinger of the user. The CPU 111 determines that the pinch operation is started when both or any one of positions that are simultaneously touched at two points is moved, or when the touch-move is detected at two points simultaneously, and position coordinates of the touch-move are changed subsequently. Further, the CPU 111 can calculate center point coordinates of the line segment that connects the two points where the pinch operation is performed and a distance between the two points. The CPU 111 instructs the display control unit 115 to enlarge a display image when a space between the two points of touched positions is increased by a value equal to or greater than a predetermined threshold value previously stored in the storage region. Similarly, the CPU 111 instructs the display control unit 115 to reduce a display image when a space between the two points of touched positions is reduced by a value equal to or greater than a predetermined threshold value previously stored in the storage region. When the finger or the pen is removed from the touch panel 118, and the touch panel 118 is touched at one point or less, the CPU 111 detects the above state as the touch-end and determines that the pinch operation is ended.

Next, a preview function provided by the MFP 101 will be described. In the present exemplary embodiment, the preview function is a function for displaying the image data stored in the RAM 112 or the external memory 120 on the display 119. The CPU 111 executes display control of displaying a preview screen including one or a plurality of pages on the display 119. In other words, the CPU 111 generates a format of image data appropriate for being displayed on the display 119 from the stored image data. Hereinafter, a format of image data appropriate for being displayed on the display 119 is referred to as a preview image. In addition, the image data stored in the external memory 120 may consist of a plurality of pages, so that a preview image is generated at each of the pages. The preview function can be used not only for viewing an image before executing printing through the printer 122, but also for various purposes of checking the contents of image data.

The MFP 101 can store the image data in the RAM 112 or the external memory 120 through various methods. For example, the MFP 101 stores image data generated by the scanner 121 by reading an image on an original document. Alternatively, the MFP 101 stores image data received from an external device such as a PC connected to the network 102 via the communication I/F controller 117. Further, the MFP 101 stores image data received from a portable storage medium such as a universal serial bus (USB) memory or a memory card attached to the external memory I/F 116. Furthermore, the MFP 101 may store image data in the external memory 120 through the other storage methods. In addition, the stored image data may be data of an original document read by the scanner 121, on which various setting contents including print settings are reflected. Further, image data displayed on the display 119 may be image data including text information, image data including image information such as a photograph or a graphic image, or image data including both of the above types of information or other types of information. Furthermore, the image data may be a sample image previously stored internally.

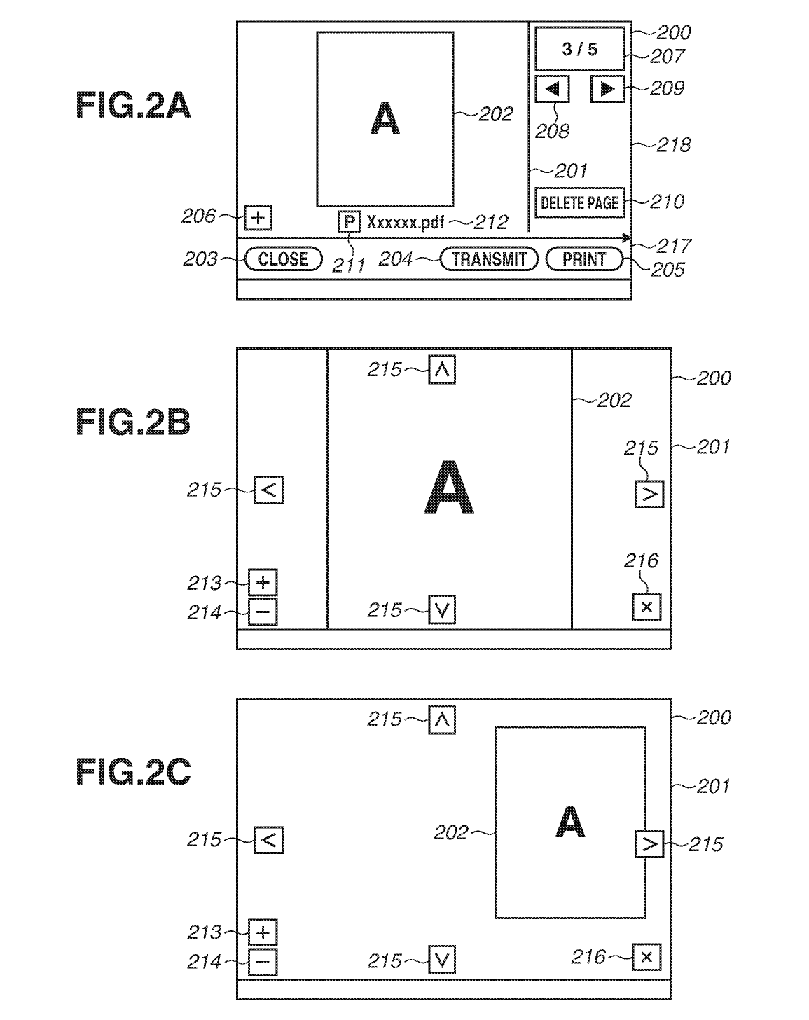

FIGS. 2A, 2B, and 2C are diagrams illustrating examples of screens illustrating preview images displayed on the display 119 of the MFP 101. A preview screen 200 in FIG. 2A is a screen for displaying a preview image, which includes a preview display region 201, a navigation region 217, and a page control region 218.

The preview display region 201 is a display region for displaying a preview image 202, which is a region capable of accepting a gesture operation of the user. In addition, in the present exemplary embodiment, although only a single page worth of preview image 202 is displayed on the preview display region 201, a plurality of pages may be displayed simultaneously.

The CPU 111 of the MFP 101 can operate display of the preview image 202 by detecting the gesture operation performed on the preview display region 201. Although examples of the gesture operation include the flick, the drag, the pinch-out, and the pinch-in that are described above, operations other than those operations may be employed as the gesture operation. Further, the region where the gesture operation is accepted may also include a region in a vicinity of the preview display region 201.

The preview image 202 is an image of stored image data reduced or enlarged to an appropriate size. Alternatively, the preview image 202 may be an image created based on various settings including a print setting set to the image data.

A close button 203 is a button for closing and shifting the preview screen 200 to another screen. When the user presses the close button 203, the CPU 111 ends the preview function.

A transmit button 204 is a button for inputting a transmission instruction of displayed image data. When the user presses the transmit button 204, the CPU 111 executes transmission processing of the image data with respect to the external apparatus such as a PC connected to the network 102 while closing and shifting the preview screen 200 to another screen. The CPU 111 hides the transmit button 204 in a state where a setting relating to transmission (i.e., transmission destination) is not performed before a screen displayed on the display 119 is shifted to the preview screen 200. Further, a stop button (not illustrated) is a button for stopping the transmission processing. When the user presses the stop button, the CPU 111 stops the transmission processing, and closes and shifts the preview screen 200 to another screen. The CPU 111 hides the stop button in a state where a setting relating to the transmission is not executed before a screen displayed on the display 119 is shifted to the preview screen 200. The close button 203 is hidden when the stop button is displayed thereon.

A print button 205 is a button for inputting a printing instruction of displayed image data. When the user presses the print button 205, the CPU 111 starts printing processing and closes and shifts the preview screen 200 to another screen. The CPU 111 hides the print button 205 in a state where a setting relating to printing such as an output paper size or a number of output copies is not executed.

A preview image enlarge button 206 is a button for enlarging and displaying the preview image 202 displayed on the preview display region 201. When the user presses the preview image enlarge button 206, the CPU 111 enlarges the preview image 202 to a predetermined display size and displays the preview image 202 on the preview display region 201.

A page number display region 207 is a display region where a total number of pages and a page number of the currently-displayed preview image 202 are displayed when the image data consists of a plurality of pages. When a displayed page is changed, the CPU 111 determines the page number of the preview image 202 and updates the display content of the page number display region 207. The example in FIG. 2A illustrates a state where a third page is currently displayed while the image data consists of a total of five pages.

A bring page backward button 208 is a button for inputting an instruction for updating the displayed preview image 202 from a current page to a previous page when the image data consists of a plurality of pages. When the user presses the bring page backward button 208, the CPU 111 reads and displays the image data of the previous page as the preview image 202 in replacement of the currently-displayed preview image 202. Alternatively, when a plurality of pages is simultaneously displayed on the preview display region 201, the CPU 111 updates the display content to make the preview image 202 corresponding to the previous page be arranged at the center of the preview display region 201.

A bring page forward button 209 is a button for inputting an instruction for changing the preview image 202 from a current page to a next page when the image data consists of a plurality of pages. When the user presses the bring page forward button 209, the CPU 111 reads and displays the image data of the next page as the preview image 202 in replacement of the currently-displayed preview image 202. Alternatively, when a plurality of pages is simultaneously displayed on the preview display region 201, the CPU 111 updates the display content to make the preview image 202 corresponding to the next page be arranged at the center of the preview display region 201.

A delete page button 210 is a button for deleting a page corresponding to the displayed preview image 202 from the image data. When the user presses the delete page button 210, the CPU 111 superimposes and displays a deletion confirmation screen (not illustrated) for allowing a user to select whether to delete the corresponding page from the image data on the preview screen 200.

A file type display region 211 is a region where a file type associated with the displayed image data is displayed. When the image data is in a portable document format (PDF), the CPU 111 displays an image representing the PDF on the file type display region 211. When the image data is in the joint photographic experts group (JPEG) format, the CPU 111 displays an image representing the JPEG. If a file type is not associated with the image data, the CPU 111 hides the file type display region 211.

A file name display region 212 is a region where a file name associated with the displayed image data is displayed. If a file name is not associated with the image data, the CPU 111 hides the file name display region 212.

The navigation region 217 is a region where various buttons for inputting a processing instruction with respect to the preview image 202 are displayed, and the close button 203, the transmit button 204, and the print button 205 are displayed thereon. The buttons and the region on the navigation region 217 are associated with a display condition of the navigation region 217. When the navigation region 217 is hidden, the close button 203, the transmit button 204 and the print button 205 are also hidden.

The page control region 218 is a region where various buttons for controlling the page of the preview image 202 displayed on the preview display region 201 are displayed. The page number display region 207, the bring page backward button 208, the bring page forward button 209, and the delete page button 210 are displayed on the page control region 218. The buttons and the region on the page control region 218 are associated with a display condition of the page control region 218. When the page control region 218 is hidden, the page number display region 207, the bring page backward button 208, the bring page forward button 209, and the delete page button 210 are also hidden.

Herein, enlarged display control of the preview image 202 executed by the pinch-out operation of the user will be described. In the present exemplary embodiment, the user can enlarge and display the preview image 202 through the pinch-out operation by touching the preview display region 201 with a finger or a pen. Along with the enlargement of the preview image 202, the navigation region 217 and the page control region 218 are hidden, so that an area occupied by the preview display region 201 in the preview screen 200 is expanded.

When the pinch-out operation is performed on the preview display region 201 and an amount of change in a distance between two points of touched positions is equal to or greater than a predetermined threshold value, the CPU 111 changes a layout of the preview screen 200 and enlarges a display size of the preview image 202 according to the amount of change. Further, the CPU 111 specifies a touch center coordinates of the two points of touched positions, and arranges the preview image 202 at a position where the preview display region 201 is expanded by making the specified touch center coordinates as a reference.

FIG. 2B is a diagram illustrating the preview screen 200 in which the CPU 111 executes enlargement of the preview image 202 and expansion of the preview display region 201 by receiving the pinch-out operation from the user. In the present exemplary embodiment, a state illustrated in FIG. 2A is referred to as a normal display mode, whereas a state illustrated in FIG. 2B is referred to as an enlarged display mode. In other words, the normal display mode refers to a state where the preview display region 201, the navigation region 217, and the page control region 218 are displayed on the preview screen 200. Further, the enlarged display mode refers to a state where the navigation region 217 and the page control region 218 are hidden from the preview screen 200, while the preview display region 201 is expanded and the buttons 213 to 216 are displayed thereon.

A preview image enlarge button 213 is a button for enlarging and displaying the preview image 202 displayed on the preview display region 201. The preview image enlarge button 213 plays a role the same as the role of the preview image enlarge button 206 in terms of a function of enlarging and displaying the preview image 202. Different magnification rates may be set to the preview image enlarge buttons 206 and 213. With this configuration, the preview image 202 can be enlarged and displayed at the magnification rate appropriate for each mode. In the present exemplary embodiment, the magnification rate is divided into four levels, and every time a press of the preview image enlarge button 213 is detected, a preview image 202 of a display size a magnification rate of which is increased by one level is displayed on the preview display region 201.

A preview image reduce button 214 is a button for reducing and displaying the preview image 202 displayed on the preview display region 201. When the user presses the preview image reduce button 214, the CPU 111 reduces the preview image 202 to a predetermined display size and displays the preview image 202 on the preview display region 201.

Preview image moving buttons 215 are buttons for moving a display position of the preview image 202 displayed on the preview display region 201. When the user presses each of the preview image moving buttons 215, the CPU 111 shifts a display position of the preview image 202 by a predetermined moving amount and displays the preview image 202 on the preview display region 201. A display position of the preview image 202 is moved in a direction indicated by each of the pressed preview image moving buttons 215.

The close button 216 is a button for ending the enlarged display mode and changing the screen arrangement to the screen arrangement of the normal display mode. When the user presses the close button 216, the CPU 111 switches the display content of the enlarged display mode to the display content of the normal display mode.

Herein, reduced display control of the preview image 202 executed by the pinch-in operation of the user will be described. In the present exemplary embodiment, the user can reduce and display the preview image 202 through the pinch-in operation by touching the preview display region 201 with a finger or a pen.

When the pinch-in operation is performed on the preview display region 201 and an amount of change in a distance between two points of touched positions is equal to or greater than a predetermined threshold value, the CPU 111 executes processing for reducing the display size of the preview image 202 according to the above-described amount of change. Further, the CPU 111 specifies a touch center coordinates of the two points of touched positions, and arranges the preview image 202 at a position where the preview display region 201 is reduced by making the specified touch center coordinates as a reference.

Further, in a case where a display size of the preview screen 200 is equal to or less than a predetermined value when the CPU 111 detects the touch-end, the CPU 111 switches the display content of the enlarged display mode to the display content of the normal display mode. Then, the CPU 111 hides the respective buttons 213 to 216 and displays the navigation region 217 and the page control region 218.

In a state where the touch panel 118 is continuously touched with the finger or the pen, the pinch-out operation and the pinch-in operation can be switched mutually and consecutively. For example, when the user consecutively increases or decreases a space between the fingers while continuously touching the touch panel 118 with two fingers, a display size of the preview image 202 is enlarged or reduced alternately. In a case where the two display modes are switched based on only a condition that whether the display size of the preview image 202 has exceeded 100% by making the display size of the preview image 202 in the normal display mode as a reference (100%), the display mode will be switched at high frequency. As a result, this will give the user a sense of flickering of the screen because of enlargement or reduction of the preview display region 201 and display or non-display of the navigation region 217 and the page control region 218.

Thus, according to the present exemplary embodiment, a condition of switching the normal display mode to the enlarged display mode through the pinch operation and a condition of switching the enlarged display mode to the normal display mode through the pinch operation are set to be different from each other. More specifically, the normal display mode is switched to the enlarged display mode based on the condition that the display size of the preview image 202 exceeds 100%. In other words, the normal display mode is switched based on the condition that a distance between the two points is increased by the pinch-out operation, and the amount of change exceeds a predetermined threshold value.

On the other hand, with respect to the condition of switching the enlarged display mode to the normal display mode, the condition is not only that the display size of the preview image 202 is reduced to 100% or less through the pinch-in operation, but also that the touch-end operation is performed. For example, if the user starts the pinch-out operation in the normal display mode to make the display size of the preview image 202 exceed 100%, the display mode is switched to the enlarged display mode even if the touch panel 118 is continuously touched with the finger or the pen. On the other hand, in a case where the user starts the pinch-in operation in the enlarged display mode, even if the display size of the preview image 202 becomes equal to or less than 100%, the display mode will not be switched to the normal display mode as long as the touch panel 118 is being touched with the finger or the pen, and the display mode is switched when the finger or the pen is removed therefrom.

Next, description will be given to a specific example of a method of changing a display position of the preview image 202 displayed on the preview display region 201. The CPU 111 of the MFP 101 specifies a direction in which the drag operation is performed and the moving amount thereof when the drag operation is detected with respect to the preview display region 201. According to the direction and the moving amount of the drag operation, the CPU 111 changes the display position of the preview image 202 in the preview display region 201. For example, with respect to the drag operation through which the touched position is moved in the right direction by a specific distance, the CPU 111 moves the display position of the preview image 202 in the right direction by the specified distance with respect to the preview display region 201. When the user performs the drag operation in the right direction after reducing and displaying the preview image 202 by performing the pinch-in operation in the enlarged display mode in FIG. 2B, the preview screen 200 will be displayed as illustrated in FIG. 2C. Herein, if the user further performs the pinch-in operation to switch the enlarged display mode to the normal display mode, the navigation region 217 and the page control region 218 are arranged in the positions that overlap with the preview image 202. Thus, when the layout of the enlarged display mode is switched to the layout of the normal display mode, the preview image 202 is moved to and displayed on a position where the preview image 202 does not overlap with the navigation region 217 and the page control region 218. For example, the preview image 202 is arranged so that the center thereof is positioned at the center of the preview display region 201 in the normal display mode. With this configuration, high operability can be provided to the user because the preview image 202 does not overlap with the navigation region 217 or the page control region 218, so that the user can press the button or check the content.

Further, the normal display mode may be switched to the enlarged display mode through the operation other than the pinch-out operation. For example, when the user presses the preview image enlarge button 206, the CPU 111 may switch the display content of the normal display mode to the display content of the enlarged display mode. Alternatively, when the user clicks the preview image 202 or the preview display region 201 in the normal display mode, the CPU 111 may switch the display content of the normal display mode to that of the enlarged display mode.

Further, display content of the enlarged display mode may be switched to the display content of the normal display mode through the operation other than the pinch-out operation and the operation of pressing the close button 216. For example, when the user presses the preview image reduce button 214, the layout of the enlarged display mode may be switched to the layout of the normal display mode if the CPU 111 determines that the display size of the preview image 202 is smaller than the predetermined display size. As described above, by allowing a user to switch the mode through a plurality of methods, the convenience of the user is improved.

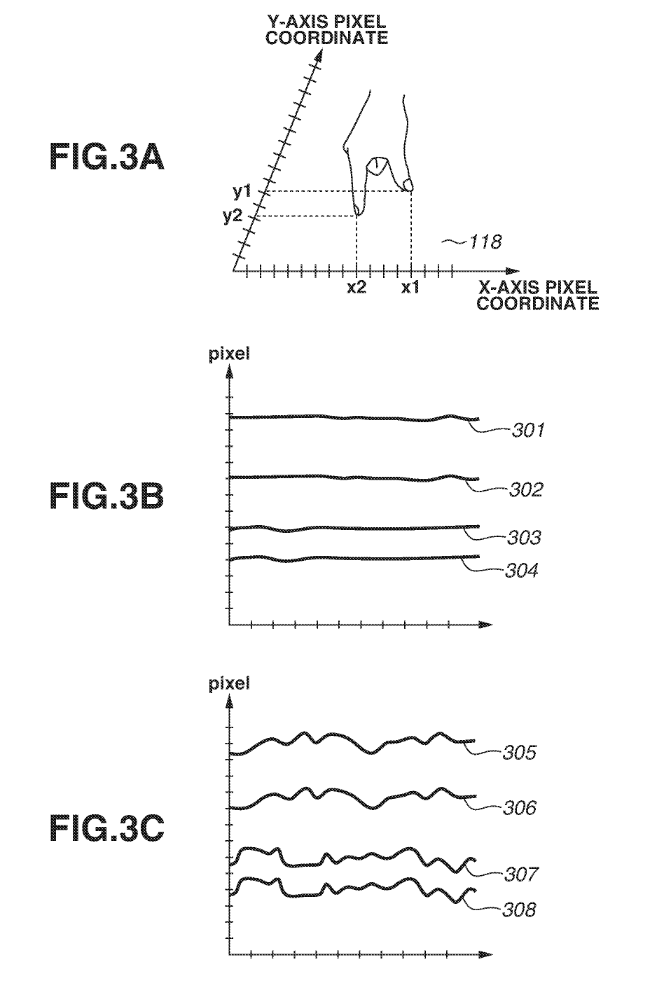

Next, a difference in position detection precisions of the electrostatic capacitance type touch panel and the resistance film type touch panel will be described with reference to a specific example. FIG. 3A is a graph illustrating an example of a state where the two fingers that touch the touch panel are held in a stationary state, and an x-axis and a y-axis represent pixel coordinates. In addition, scales are marked at intervals of 5-pixel.

FIG. 3B is a graph illustrating time variations of position coordinates detected when the touch operation in FIG. 3A is performed on the electrostatic capacitance type touch panel. FIG. 3C is a graph illustrating time variations of position coordinates detected when the touch operation in FIG. 3A is performed on the resistance film type touch panel. In both of the FIGS. 3B and 3C, vertical axes represent pixel coordinates, and scales are marked at intervals of 5-pixel. Further, horizontal axes represent time, and scales are marked at intervals of 10-millisecond (ms).

Lines 301, 302, 303, and 304 in the graph in FIG. 3B respectively correspond to an x1-coordinate, an x2-coordinate, a y1-coordinate, and a y2-coordinate in FIG. 3A. Similarly, lines 305, 306, 307, and 308 in the graph in FIG. 3C respectively correspond to the x1-coordinate, the x2-coordinate, the y1-coordinate, and the y2-coordinate in FIG. 3A. As described above, in the electrostatic capacitance type, position information can be acquired with high precision because a position is detected by capturing a change in the electrostatic capacitance between fingers and a conductive film. Thus, as illustrated in FIG. 3B, variation arising in the detected coordinates is small when the fingers are held in a stationary state. On the other hand, in the resistance film type, because a position is detected through a pressure applied by a finger or a stylus pen, precision of the position detection is lower than that of the electrostatic capacitance type. Thus, as illustrated in FIG. 3C, variation arising in the detected coordinates is large even though the fingers are held in a stationary state.

As described above, if a threshold value for determining whether to enlarge or reduce the image is set to be the same with respect to the electrostatic capacitance type and the resistance film type, there is a possibility that an image is enlarged or reduced without intention of the user. The above issue will be described with reference to a specific example. When a threshold value appropriate for the electrostatic capacitance type is “α” whereas a threshold value appropriate for the resistance film type is “β”, generally, the magnitude relation thereof is “α<β”. Because detection precision of coordinates is lower in the resistance film type than in the electrostatic capacitance type, variation arises in the detected coordinates as illustrated in FIG. 3C. Thus, in order to prevent the image from being enlarged or reduced without intention of the user, a threshold value for the resistance film type is set to be greater. Herein, if the resistance film type touch panel is connected in a state where the threshold value α is set thereto, the amount of change in a distance between the two points exceeds the threshold value α because of the variation arising in the detected coordinates, and thus the image may be enlarged or reduced even if the two fingers are held in a stationary state while touching the touch panel. On the contrary, if the electrostatic capacitance type touch panel is connected in a state where the threshold value β is set thereto, enlargement or reduction will not be executed until the amount of change thereof exceeds the threshold value β, and thus enlarged display or reduced display cannot be executed smoothly and comfortably even if the user performs the pinch operation in order to enlarge or reduce the image.

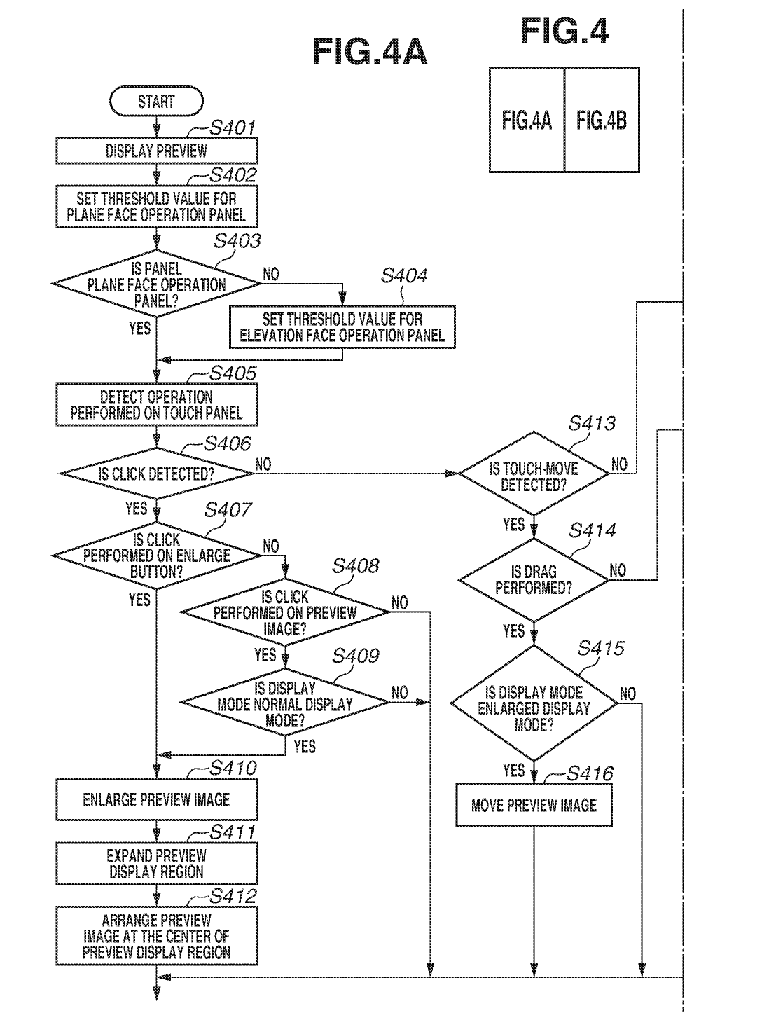

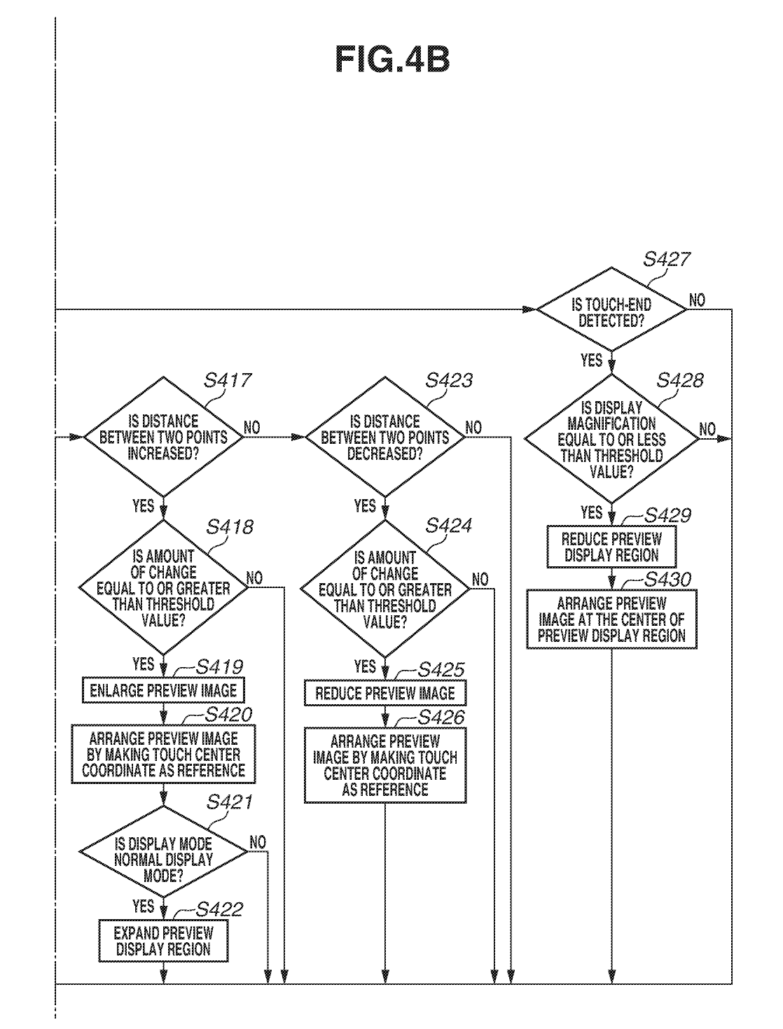

As such, a method for solving the above situations will be described below. FIG. 4 (4A and 4B) is a flowchart illustrating processing executed by the MFP 101 when the preview images illustrated in FIGS. 2A to 2C are displayed on the display 119. Processes in the steps in FIG. 4 (4A and 4B) are implemented by the CPU 111 executing a program stored in the ROM 113 or the external memory 120.

In step S401, the CPU 111 and the display control unit 115 display a preview screen 200 on the display 119 according to a predetermined user's operation.

In step S402, the CPU 111 sets a threshold value for the plane face operation panel as an initial value. Herein, a threshold value a is set as the initial value because the plane face operation panel is the electrostatic capacitance type.

In step S403, the CPU 111 determines whether the connected operation panel is the plane face operation panel. If the elevation face operation panel is attached to the MFP 101 at the time of installation, a service engineer sets a flag of an elevation face operation panel mode. The CPU 111 determines whether the connected operation panel is the plane face operation panel by checking this flag. In addition, a flag of the plane face operation panel is set as a default. If the connected operation panel is determined as a plane face operation panel (YES in step S403), the processing proceeds to step S405. If the connected operation panel is not determined as a plane face operation panel but an elevation face operation panel (NO in step S403), the processing proceeds to step S404.

In step S404, the CPU 111 sets a threshold value for the elevation face panel. Herein, the threshold value β is set thereto. In addition, the threshold value β has a value greater than the threshold value α.

In step S405, the CPU 111 receives a user's operation performed on the touch panel 118.

In step S406, the CPU 111 determines whether the operation detected in step S405 is a click operation. If the operation is determined as the click operation (YES in step S406), the processing proceeds to step S407. If the operation is not determined as the click operation (NO in step S406), the processing proceeds to step S413.

In step S407, the CPU 111 determines whether the click operation is performed on the preview image enlarge button 206. If the operation is determined as the click operation performed on the preview image enlarge button 206 (YES in step S407), the processing proceeds to step S410. If the operation is determined as the click operation that is not performed on the preview image enlarge button 206 (NO in step S407), the processing proceeds to step S408.

In step S408, the CPU 111 determines whether the click operation is performed on the preview image 202. If the operation is determined as the click operation performed on the preview image 202 (YES in step S408), the processing proceeds to step S409. If the operation is determined as the click operation that is not performed on the preview image 202 (NO in step S408), the CPU 111 does not change the display of the preview image 202 and the preview display region 201. In the above, although the processing other than change of display will be executed with respect to the preview image 202 and the preview display region 201, description thereof will be omitted as the processing does not directly relate to the aspect of the embodiments.

In step S409, the CPU 111 determines whether display content of the current preview screen 200 is the display content of the normal display mode. The CPU 111 switches the display mode to the enlarged display mode to expand the preview display region 201 by accepting the click operation performed on the preview image 202 only in the normal display mode. If the CPU 111 determines that the display mode is the normal display mode (YES in step S409), the processing proceeds to step S410. If the display mode is not determined as the normal display mode (NO in step S409), the CPU 111 does not change the display of the preview image 202 and the preview display region 201.

In step S410, the CPU 111 enlarge the display size of the preview image 202.

In step S411, the CPU 111 expands the preview display region 201 by hiding the navigation region 217 and the page control region 218. In step S412, the CPU 111 changes the display position of the preview image 202 so as to make the center of the preview image 202 in the enlarged display size and the center of the expanded preview display region 201 be positioned at the same position.

In step S413, the CPU 111 determines whether the event detected in step S405 is the touch-move. If the event is determined as the touch-move (YES in step S413), the processing proceeds to step S414. If the event is not determined as the touch-move (NO in step S413), the processing proceeds to step S427.

In step S414, based on the detected touch-move event, the CPU 111 determines whether the operation performed by the user is the drag operation. If the touch-move event is detected at one point while a change of the position coordinates becomes a predetermined distance or more, the operation is determined as the drag operation. If the touch-move event is detected at two points, the operation is not determined as the drag operation. If the operation is determined as the drag operation (YES in step S414), the processing proceeds to step S415. If the operation is not determined as the drag operation (NO in step S414), the processing proceeds to step S417.

In step S415, the CPU 111 determines whether the current preview screen 200 is displayed in the enlarged display mode. The CPU 111 changes the display position of the preview image 202 by accepting the drag operation performed on the preview image 202 only in the enlarged display mode. If the display mode is determined as the enlarged display mode (YES in step S415), the processing proceeds to step S416. If the display mode is not determined as the enlarged display mode (NO in step S415), the CPU 111 does not change the display of the preview image 202 and the preview display region 201. Then, in step S416, the CPU 111 changes the display position of the preview image 202 in the preview display region 201 according to the direction and the moving amount of the drag operation.

In step S417, based on the change in the position coordinates of the touch-move event detected at the two points, the CPU 111 determines whether a distance between the two points of touched positions is increased. If the CPU 111 determines that the distance between the two points of touched positions is increased (YES in step S417), the processing proceeds to step S418. If the CPU 111 determines that the distance between the two points of touched positions is not increased (NO in step S417), the processing proceeds to step S423.

In step S418, the CPU 111 determines whether the amount of change in the distance between the two points of touched positions is equal to or greater than the threshold value set in step S402 or S404. In other words, the CPU 111 determines whether a difference between the distance at the time of firstly detecting the two points of touched positions and the distance after at least any one of the two points has moved exceeds the above threshold value. If the amount of change is equal to or greater than the threshold value (YES in step S418), the processing proceeds to step S419. If the amount of change is less than the threshold value (NO in step S418), the CPU 111 does not change the display of the preview image 202 and the preview display region 201.

In step S419, the CPU 111 enlarges the display size of the preview image 202 according to the amount of change in the distance between the two points of touched positions. In step S420, the CPU 111 arranges the preview image 202 at a position that is enlarged by making the touch center coordinates as a reference.

In step S421, the CPU 111 determines whether the current preview screen 200 is displayed in the normal display mode. If the display mode is determined as the normal display mode (YES in step S421), the processing proceeds to step S422. If the display mode is not determined as the normal display mode (NO in step S421), the CPU 111 does not change the display of the preview screen 202 and the preview display region 201.

In step S422, the CPU 111 expands the preview display region 201 by hiding the navigation region 217 and the page control region 218. In other words, the CPU 111 switches the display mode from the normal display mode to the enlarged display mode by accepting the pinch-out operation only in the normal display mode.

In step S423, based on the change in the position coordinates of the touch-move event detected at two points, the CPU 111 determines whether a distance between the two points of touched positions is decreased. If the CPU 111 determines that the distance between the two points of touched positions is decreased (YES in step S423), the processing proceeds to step S424. If the CPU 111 determines that the distance between the two points of touched positions is not decreased (NO in step S423), the CPU 111 does not change the display of the preview image 202 and the preview display region 201.

In step S424, the CPU 111 determines whether an amount of change in the distance between the two points of touched positions is equal to or greater than the threshold value set in step S402 or S404. In other words, the CPU 111 determines whether a difference between the distance at the time of firstly detecting the two points of the touched positions and the distance after at least any one of the two points has moved exceeds the above threshold value. If the amount of change is equal to or greater than the threshold value (YES in step S424), the processing proceeds to step S425. If the amount of change is less than the threshold value (NO in step S424), the CPU 111 does not change the display of the preview image 202 and the preview display region 201.

In step S425, the CPU 111 reduces the display size of the preview image 202 according to the amount of change in the distance between two points of touched positions. In step S426, the CPU 111 arranges the preview image 202 at a position that is reduced by making the touch center coordinates as a reference.

In step S427, the CPU 111 determines whether the event detected in step S405 is the touch-end. If the event is determined as the touch-end (YES in step S427), the processing proceeds to step S428. If the event is not determined as the touch-end (NO in step S427), the CPU 111 determines that the display does not have to be changed and ends the processing.

In step S428, the CPU 111 determines whether the display size of the preview image 202 is equal to or less than a predetermined threshold value of the image size (hereinafter, referred to as “image threshold value”). If the accepted event is a touch-end operation in which the finger or the pen is removed after the pinch-in operation, which makes the display size of the preview image 20 be equal to or less than the threshold value, the display content of the enlarged display mode is switched to the display content of the normal display mode. Herein, when a display size of the preview image 202 displayed in the normal display mode is set as a reference (display magnification of 100%), a condition of switching the display mode to the normal display mode is that the display magnification is reduced to 100% through the pinch-in operation. In the present exemplary embodiment, a display size of the preview image 202 displayed in the normal display mode is set as the image threshold value. If the CPU 111 determines that the display size of the preview image 202 is equal to or less than the predetermined image threshold value (YES in step S428), the processing proceeds to step S429. If the display size of the preview image 202 is greater than the predetermined image threshold value (NO in step S428), the processing is not executed.

In step S429, the CPU 111 hides all or a part of the buttons 213 to 216, displays the navigation region 217 and the page control region 218, and reduces the preview display region 201. In other words, the CPU 111 switches the display content of the enlarged display mode to the display content of the normal display mode.

In step S430, the CPU 111 changes a display position of the preview image 202 so as to make the center of the preview image 202 and the center of the reduced preview display region 201 be positioned at the same position.

As described above, according to the present exemplary embodiment, a threshold value as a determination reference of whether to enlarge or reduce an image through the pinch operation is changed according to whether a type of the connected touch panel is the electrostatic capacitance type or the resistance film type. Thus, processing of enlarging or reducing the image that is not intended by the user can be suppressed from being executed because an appropriate threshold value is set according to the type of the connected touch panel. More specifically, the threshold value used when the electrostatic capacitance type touch panel is connected is set to be smaller than the threshold value used when the resistance film type touch panel is connected. Therefore, when the electrostatic capacitance type touch panel is connected, the user can perform enlargement and reduction smoothly and comfortably. On the other hand, when the resistance film type touch panel is connected, it is possible to suppress such a situation in which the image is enlarged or reduced even though the user holds the finger in a stationary state.

While the disclosure has been described in detail with reference to the exemplary embodiments, it is to be understood that the disclosure is not limited to the above-described specific exemplary embodiments, and many variations which do not depart from the spirit of the aspect of the embodiments should be included within the scope of the disclosure. Further, a part of the above-described exemplary embodiments may be combined as appropriate.

In the above-described exemplary embodiment, although description has been given to an exemplary embodiment in which the same value is set to the threshold value for determining whether to enlarge the image and the threshold value for determining whether to reduce the image, different values may be set thereto.

Further, in the above-described exemplary embodiment, as a method for determining whether a type of the connected touch panel is the electrostatic capacitance type or the resistance film type, description has been given to a method using a flag that indicates whether the connected touch panel is the plane face operation panel or the elevation face operation panel. However, another method may be employed. For example, a type of the connected touch panel may be determined based on a signal transmitted when the touch panel is connected.

Further, in the above-described exemplary embodiment, although an exemplary embodiment in which the electrostatic capacitance type is employed for a plane face operation panel whereas the resistance film type is employed for an elevation face operation panel has been described, the resistance film type may be employed for the plane face operation panel whereas the electrostatic capacitance type may be employed for the elevation face operation panel. Further, in the above-described exemplary embodiment, although an exemplary embodiment in which one of the operation panels is the plane face operation panel whereas the other is the elevation face operation panel has been described, both of the operation panels may be the plane face operation panels or the elevation face operation panels.

Further, in the above-described exemplary embodiment, although an exemplary embodiment employing the electrostatic capacitance type and the resistance film type touch panels has been described, a touch panel of another type may be employed. In other words, the disclosure is applicable to an information processing apparatus to which a plurality of touch panels of different types is connectable. Further, in the above-described exemplary embodiment, description has been given by taking a preview screen as an example. However, the aspect of the embodiments is not limited to the preview screen, and it is obvious that the aspect of the embodiments is applicable to a screen enlargement/reduction function for enlarging and reducing the entire screen through the pinch operation.

Further, in the above-described exemplary embodiment, although the MFP has been described as an example of the apparatus embodying the disclosure, the apparatus that embodies the disclosure is not limited to the MFP. In other words, the aspect of the embodiments is applicable to an image processing apparatus such as a printer, a scanner, a facsimile, a copying machine, or a multifunction peripheral, a personal computer, a personal digital assistance (PDA), a camera-equipped mobile phone terminal, a video camera, and other image viewers.

According to the aspect of the embodiments, in an information processing apparatus to which a plurality of touch panels of different types can be connected, a threshold value for determining whether to enlarge or reduce an image according to a pinch operation can be appropriately set according to the type of a connected touch panel.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2015-232524, filed Nov. 28, 2015, which is hereby incorporated by reference herein in its entirety.

What is claimed is:

1. An information processing apparatus comprising:
a connection unit configured to connect a touch panel of a first type or a touch panel of a second type;
a display unit configured to display an image;
a calculation unit configured to calculate a distance between at least two points of touched positions on a touch panel connected to the connection unit;
a display control unit configured to enlarge or reduce the displayed image according to an amount of change in the calculated distance exceeding a threshold value; and
a setting unit configured to set different values between the threshold value used when the touch panel of the first type is connected to the connection unit and the threshold value used when the touch panel of the second type is connected to the connection unit.

2. The information processing apparatus according to claim 1, wherein the first type is an electrostatic capacitance type and the second type is a resistance film type.

3. The information processing apparatus according to claim 2, wherein the setting unit sets the values such that the threshold value used when the touch panel of the resistance film type is connected to the connection unit is greater than the threshold value used when the touch panel of the electrostatic capacitance type is connected to the connection unit.

4. The information processing apparatus according to claim 2, wherein the touch panel of the electrostatic capacitance type is a plane face operation panel and the touch panel of the resistance film type is an elevation face operation panel.

5. The information processing apparatus according to claim 4, wherein the setting unit sets the threshold value for the touch panel of the electrostatic capacitance type as an initial value, and changes the initial value to the threshold value for the touch panel of the resistance film type according to the elevation face operation panel being connected.

6. The information processing apparatus according to claim 1, wherein the setting unit sets different values between the threshold value for enlarging the displayed image and the threshold value for reducing the displayed image.

7. The information processing apparatus according to claim 1, further comprising a reading unit configured to generate image data by reading an image on an original document.

8. The information processing apparatus according to claim 7, wherein the display unit displays a preview image based on the generated image data.

9. The information processing apparatus according to claim 1, further comprising a printing unit configured to print image data on a recording material.

10. A control method of an information processing apparatus including a connection unit configured to connect a touch panel of a first type or a touch panel of a second type, and a display unit configured to display an image, the control method comprising:
calculating a distance between at least two points of touched positions on a touch panel connected to the connection unit;
enlarging or reducing the displayed image according to an amount of change in the calculated distance exceeding a threshold value; and
setting different values between the threshold value used when the touch panel of the first type is connected to the connection unit and the threshold value used when the touch panel of the second type is connected to the connection unit.

11. The control method according to claim 10, wherein the first type is an electrostatic capacitance type and the second type is a resistance film type.

12. The control method according to claim 10, wherein the setting sets different values between the threshold value for enlarging the displayed image and the threshold value for reducing the displayed image.

13. The control method according to claim 10, further comprising generating image data by reading an image on an original document.

14. The control method according to claim 10, further comprising printing image data on a recording material.

15. A non-transitory computer readable storage medium storing a computer program for causing a computer to execute a control method of an information processing apparatus, which includes a connection unit configured to connect a touch panel of a first type or a touch panel of a second type and a display unit configured to display an image, the control method comprising:
calculating a distance between at least two points of touched positions on a touch panel connected to the connection unit;
enlarging or reducing the displayed image according to an amount of change in the calculated distance exceeding a threshold value; and
setting different values between the threshold value used when the touch panel of the first type is connected to the connection unit and the threshold value used when the touch panel of the second type is connected to the connection unit.

16. The non-transitory computer readable storage medium according to claim 15, wherein the first type is an electrostatic capacitance type and the second type is a resistance film type.

17. The non-transitory computer readable storage medium according to claim 10, wherein the setting sets different values between the threshold value for enlarging the displayed image and the threshold value for reducing the displayed image.

18. The non-transitory computer readable storage medium according to claim 15, further comprising generating image data by reading an image on an original document.

19. The non-transitory computer readable storage medium according to claim 15, further comprising printing image data on a recording material.
